(19) United States
(12) Patent Application Publication
(10) Pub. No.: US 2006/0177044 A1
(43) Pub. Date: Aug. 10, 2006

(54) Methods, systems, and computer program products for providing tone services

(76) Inventors: Douglas O'Neil, (US); Douglas Alston, (US)

Correspondence Address: CANTOR COLBURN LLP - BELLSOUTH, 55 GRIFFIN ROAD SOUTH, BLOOMFIELD, CT, 06002, US

(21) Appl. No.: 11/040,509

(22) Filed: Jan. 21, 2005

(51) Int. Cl. H04M 1/00

(52) U.S. Cl. 379/373.02

(57) ABSTRACT

Methods, systems, and computer program products for providing tone services are provided. Methods include associating a tone with a communications address and storing results of the associating in a profile record. In response to receiving an incoming call directed to the communications address, the methods include accessing the profile record to find the tone and delivering the tone along with the incoming call to a communications device associated with the communications address.

### BACKGROUND

Exemplary embodiments relate generally to communications services, and more particularly, to methods, systems, and computer program products for providing tone services.

Most communications devices today come with a selection of ring tones and/or video tones from which a user may select and implement on the device. This is generally accomplished via a menu option that is provided on the device whereby a user may first preview a sampling of each of the listed ring/video tones prior to selecting one from the list. Users of these devices may also select multiple ring/video tones and associate one or more of them with a particular telephone number or communications address such that an incoming call may be identified by the particular ring/video tone assigned to the originating caller. If a desired ring/video tone does not appear on the list of tones stored within the communications device, some service providers offer the ability to download to the device a desired ring/video tone over a network, typically for a fee. The ring/video tone is then downloaded and available to the user only on that device for which the ring/video tone was downloaded. In other words, if the user desires to utilize a particular ring/video tone for other devices (e.g., other telephones or communications devices), the user needs to individually download the desired ring/video tone to each of the devices. This process is clearly time consuming and can also be quite expensive, particularly in situations whereby fees are incurred on a ‘per download’ basis. Additionally, individuals oftentimes get bored with a particular ring/video tone and wish to periodically update one or more ring/video tones across multiple devices.

What is needed is a way to provide ring/video tones and related services to a variety of devices associated with a user and which is efficient and simple to manage.

### SUMMARY

The above disadvantages and shortcomings and others are overcome or alleviated by methods, systems, and computer program products for providing tone services, such as ring/video tone services, to one or more devices operated or controlled by an individual. Methods include associating a tone with a communications address and storing results of the associating in a profile record. In response to receiving an incoming call directed to the communications address, the methods include accessing the profile record to find the tone and delivering the tone along with the incoming call to a communications device associated with the communications address.

Systems for providing ring/video tone services include a processor executing a ring tone service manager application. The processor is in communication with a communications device via a network. The ring tone service manager application associates a tone with a communications address and stores results of the association in a profile record. In response to receiving an incoming call directed to the communications address, the ring tone service manager application accesses the profile record to find the tone and delivers the tone along with the incoming call to a communications device associated with the communications address.

Computer program products for providing ring/video tone services comprise instructions for associating a tone with a communications address and storing results of the associating in a profile record. In response to receiving an incoming call directed to the communications address, the methods include accessing the profile record to find the tone and delivering the tone along with the incoming call to a communications device associated with the communications address.

A communications device for providing ring/video tone services includes a synchronization protocol enabled on the communications device and a ring tone client application executing on the communications device. The ring tone client application downloads a tone on the communications device, applies distinctive ring settings to the communications device, automatically transmits the tone and the distinctive ring settings to an other communications device via the synchronization protocol, and implements the tone on the communications device.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF DRAWINGS

Referring now to the drawings wherein like elements are numbered alike in the several FIGURES:

FIG. 1 is block diagram of a system upon which the ring tone services may be implemented in exemplary embodiments;

FIG. 2 is a user interface screen depicting a sample menu of options available through the ring tone service system in exemplary embodiments;

FIG. 3 is a user interface screen depicting a sample user profile created via the ring tone service system in exemplary embodiments;

FIG. 4 is a sample electronic address book through which ring tone settings may be managed via the ring tone service system in exemplary embodiments;

FIG. 5 is a flow diagram describing a process for implementing device-based features of the ring tone service system with device synchronization in exemplary embodiments; and

FIG. 6 is a flow diagram describing a process for implementing the network-based features of the ring tone service system in exemplary embodiments.

### DETAILED DESCRIPTION OF EXEMPLARY EMBODIMENTS

In accordance with exemplary embodiments, a tone service system provides network-delivered and/or client device-based ring tone/video tone services (e.g., ring tones, video tones, and ring back tones). Network-based implementations include delivering a selected ring/video tone to a device during a call set up. The client device-based implementation provides control logic resident within the device for implementing the services. For ease of explanation, the ring tone service system is described herein with reference to ring tones. However, it will be understood that the services may be provided for other tones, e.g., video tones, as well. The ring tone service system supports distinctive ringing across multiple devices, which may be under the control of a single user. Such devices may include Voice over the Internet Protocol (VoIP) and Session Initiated Protocol (SIP) telephones phones, cordless SIP phones, cordless Wireless Fidelity (WiFi) SIP phones, cellular phones, and SIP clients on any device, such as a personal computer. The ring tone services may be implemented, e.g., by incorporating a simple web-based user interface whereby a device user may control and manage his/her ring tones across all of the devices owned or controlled by the user.

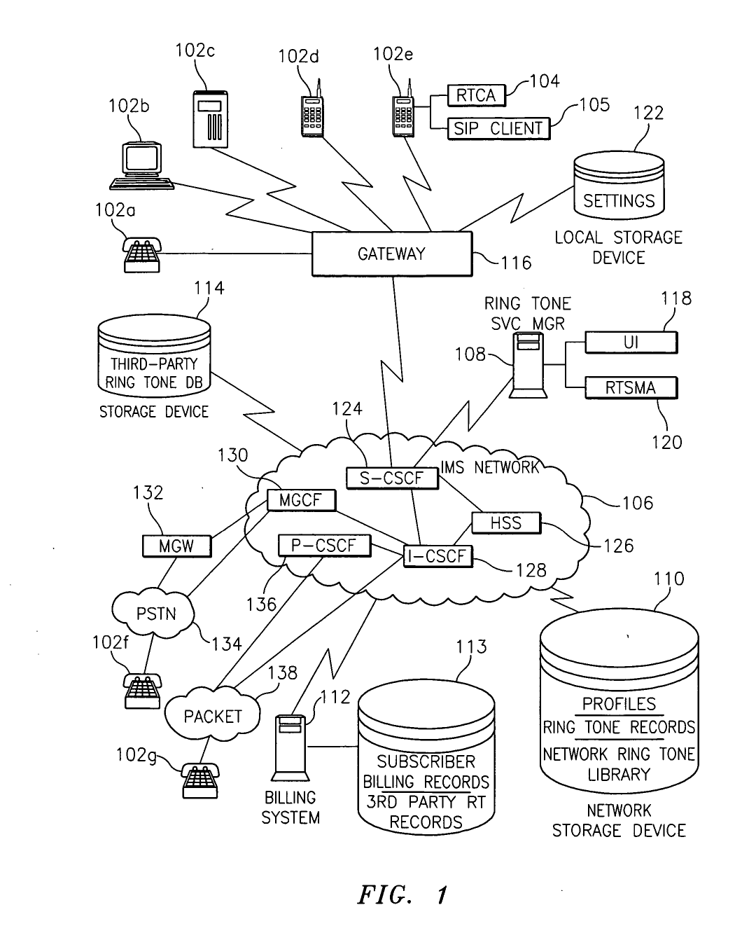

Turning now to FIG. 1, a system upon which the ring tone services may be implemented in exemplary embodiments will now be described. The system of FIG. 1 includes multiple communications devices 102a-e in communication with a network 106 (e.g., an Internet Protocol Multi-Media Subsystem (IMS) network) via, e.g., a gateway 116. Also included in the system of FIG. 1 is a ring tone service manager 108 that communicates with one or more communications devices 102a-e via the network 106.

Communications device 102a may be a wireline telephone utilizing Internet telephony technology, such as an Internet telephony service provider service along with a unique code that is entered into the device 102a prior to entering the telephone number to be called. With the advent of gateway servers and (VoIP) protocols, communications device 1 02a may initiate a telephone call that is processed and transmitted over a combination of networks, e.g., circuit-switched and packet-switched networks. For example, communications device 102a may communicate utilizing SIP, a signaling protocol for Internet telephony. The SIP initiates call setup, routing, authentication, and other feature messages to endpoints within an Internet Protocol (IP) domain.

Communications device 102b may include a wireless or wireline computer device such as a personal computer or laptop. With the proper tools (e.g., an Internet service subscription and modem, voice communications software, a microphone, sound card, and receiver), communications device 102b may implement voice communications over a packet-switched network, in addition to the more traditional digital-based transmissions. The computer may be a personal computer (e.g., desktop, laptop) that communicates over a network (e.g., network 106) using an Internet service provider (ISP). Communications device 102b may also communicate over the Internet utilizing, e.g., digital subscriber line (DSL), cable, dial-up, wireless communications protocols (Bluetooth, WAP, etc.), and/or other known networking technologies.

Communications device 102c may be implemented by a pager or similar device comprising a wireless receiver that provides messaging capabilities. When triggered, pager 102c may beep or vibrate indicating an incoming message. The message may be transmitted to pager 102c via short messaging service (SMS) protocols and may be alphanumeric or a text message. Receiver 102c may include some processor-enabled functionality for enabling the ring tone services described herein. A variety of high-end pagers today incorporate some processor-enabled functionality as will be appreciated by those skilled in the art.

Communications device 102d refers to a cordless, WiFi/SIP or dual mode enabled cordless telephone and mobile handset. A dual mode telephone such as communications device 102d may operate on either 800 MHz or 1900 MHz and may support both Code Division Multiple Access (CDMA) or the Global Standard for Mobiles (GSM) technologies. The dual mode enabled by communications device 102d refers to the type of transmission technology used by the device. For example, if communications device 102d supports Advanced Mobile Phone System (AMPS) and Time Division Multiple Access (TDMA), it could switch back and forth as needed to support both types of transmission types. Similarly, the dual mode device 102d may support both WiFi and GSM, and have capability to switch back and forth as needed to support both types of transmissions.

Communications device 102e may be implemented by a mobile computing device with telephone communications features (e.g., enhanced personal digital assistant).

Users of communications devices 102a-e are also referred to herein as ‘customers’, ‘subscribers’, and ‘account holders’. These terms are used interchangeably throughout this description.

Gateway 116 refers to a network element that manages the communications initiated by communications devices 102a-102e. For illustrative purposes, the communications devices 102a-102e represent multiple devices under the operation and control of a single user. For example, communications devices 102a-e may be located within a user residence. In accordance with exemplary embodiments, gateway 116 includes a SIP-enabled residential gateway that utilizes, for example, an open source application based upon the Session Initiation Protocol (SIP). Gateway 116 may also include an IP telephony gateway that allows a SIP user device (e.g., devices 102a-e) to make and receive calls between various network types, e.g., Plain Old Telephone Network (PSTN) and a SIP-based network. An example of current technology for supporting this type of gateway includes the SIP Residential Gateway (SIPRG), an open source application developed by Tata Infotech Ltd of India or 2Wire, Inc. of the U.S.A.

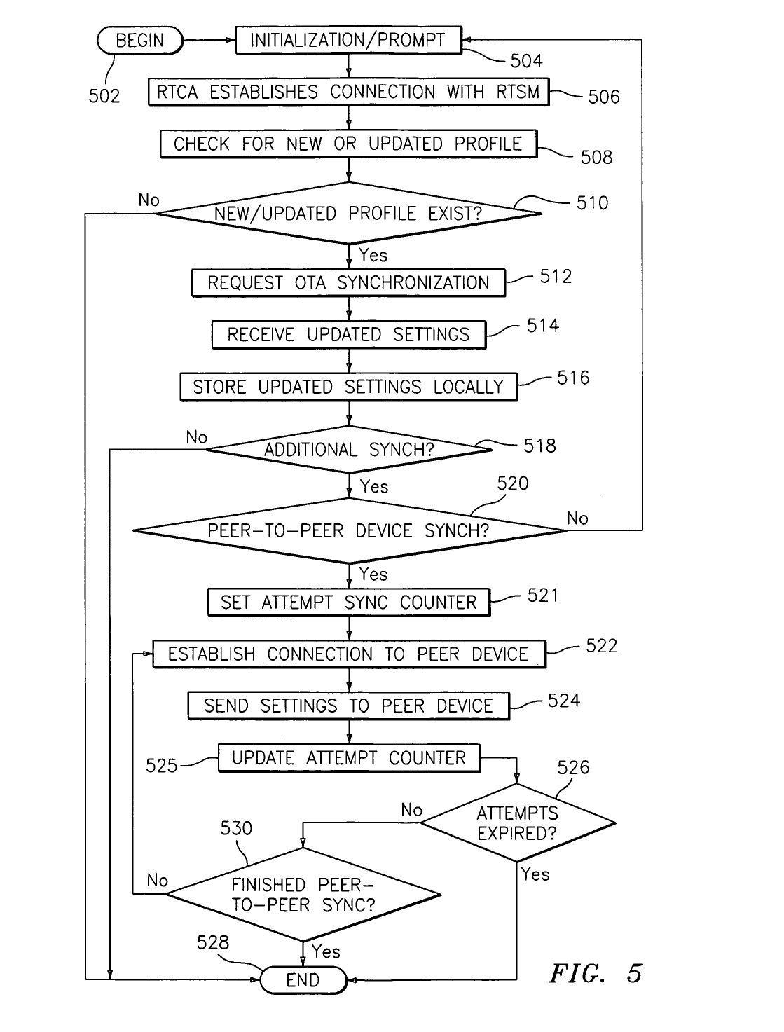

In accordance with exemplary embodiments, the ring tone services, or a portion thereof, may be implemented via a client application associated with one or more of communications devices 102a-e. The client device-oriented implementation is described further herein with respect to the flow diagram of FIG. 5. The client application is referred to herein as the ring tone client application 104 and is shown in FIG. 1 with reference to communications device 102e for illustrative purposes. The ring tone client application 104 may be integrated with a SIP client 105 for enabling the processes described herein. It will be understood that other communications devices may implement the ring tone client application 104 in addition to, or in lieu of, communications device 102e. In addition, it will be understood that a variety of other types of communications devices may be serviced by the ring tone service system and that the representation of devices 102a-e are for illustrative purposes and are not intended to be limiting in scope.

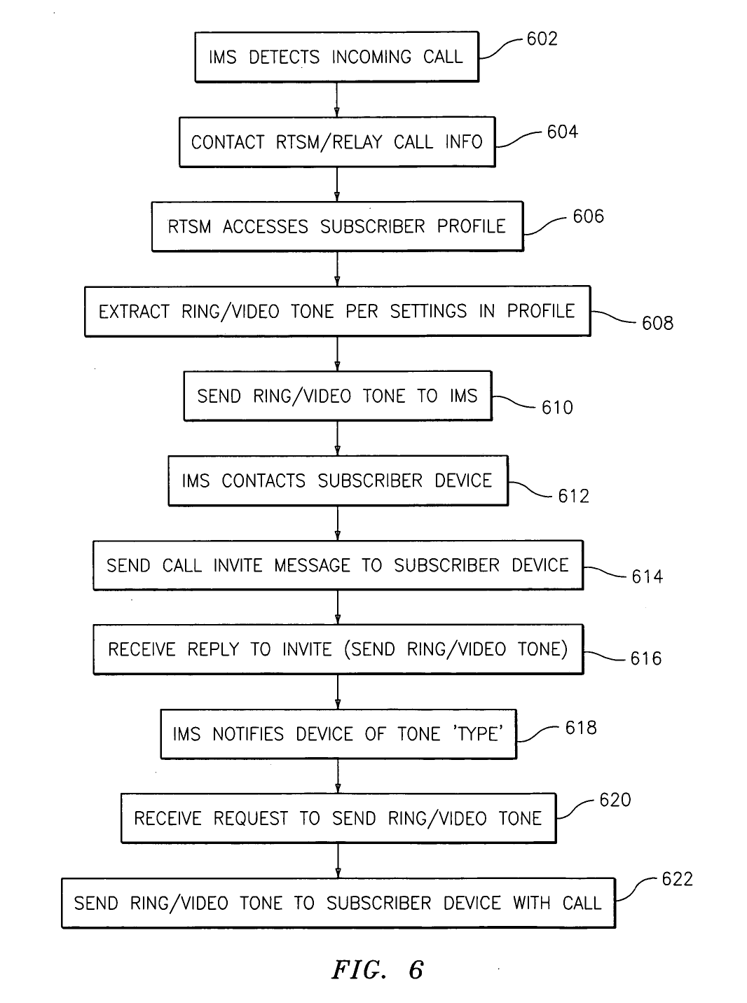

In alternate exemplary embodiments, the ring tone services may be implemented over a network (e.g., IMS network 106). The ring tone service manager 108 executes a ring tone service manager application 120 for providing these network-based services as will be described further in the flow diagram of FIG. 6. Ring tone service manager 108 may be implemented, e.g., by a service provider enterprise that provides telephone, Internet, messaging services, etc. via one or more network configurations to its customers or subscribers. These multiple network configurations may include, e.g., standard PSTN or circuit-switched networks and packet-switched networks, which, in turn, utilize Internet Protocol (IP), asynchronous transfer mode (ATM), and frame relay protocols for transmitting digital data.

Service providers may include telephony service providers such as local exchange and interexchange carriers including incumbent and/or competitive exchange carriers. Service providers may further include, or be in communication with, Internet service providers, wireless telephone service providers, Internet telephony service providers, to name a few. By communicating with various types of service provider entities, disparate types of communications and networks can be seamlessly integrated. For example, a voice call initiated from a standard wireline telephone may be processed by a telephone service provider, transmitted to a softswitch where it is converted into digital format, transmitted over an IP network to a second telephone service provider where it is converted to analog format and terminated at a receiving communications device.

Ring tone service manager 108 may be implemented using one or more servers operating in response to a computer program stored in a storage medium accessible by the server. The ring tone service manager 108 may operate as a network server (e.g., a web server) to communicate with communications devices 102a-e. The ring tone service manager 108 may also operate as an application server, executing one or more computer programs to provide ring tone services. These one or more computer programs are referred to collectively herein as the ring tone service manager application 120. As previously described, it is understood that separate servers may be utilized to implement the network server functions and the application server functions. Alternatively, the network server and the application server may be implemented by a single server executing computer programs to perform the requisite functions.

IMS network 106 may comprise a multiprotocol label switching (MPLS) network which employs various routers in a manner that eliminates the need for multiple layers that exist in most carrier networks (e.g., SONET/SDH deployed at layer 1, ATM at layer 2, and IP at layer 3). IMS network 106 may utilize several standards adopted by the Internet Engineering Task Force (IETF) organization and may support the Internet Protocol, Asynchronous Transport Mode (ATM), and frame relay network protocols, among others. IMS network 106 receives signals from network entities such as ring tone service manager 108, as well as from outside entities such as third-party storage device 114, billing system 112, communications devices 102f-102g, etc.

Elements of the IMS network 106 include a serving call session control function (S-CSCF) 124, a home subscriber system (HSS) 126, an interrogating call session control function (I-CSCF) 128, a media gateway control function (MGCF) 130, and a proxy call session control function (P-CSCF) 136. Serving call session control function (S-CSCF) 124 refers to a network element that controls the call session for the endpoint devices in the call. When a user's device (e.g., communications devices 102a-e) registers with the ring tone service system, the S-CSCF 124 interrogates the home subscriber system (HSS) 126 and extracts information relating to the subscriber's services, initial filter criteria, and the addresses of the filters associated with the subscriber's services. The initial filter criteria includes call control service logic that defines the services to which the customer has subscribed, the conditions under which the services are invoked, and the network addresses of the application servers that provide the services to the subscribing customer. The filters associated with the subscriber's services are also known as application servers that provide the services to which the customer has subscribed. The S-CSCF 124 sets up call sessions with the subscriber's device, engages the ring tone service manager 108 during the call setup, establishes the call session with the answering device (or applies secondary call treatment, if applicable), and ends the call session upon receipt of a call termination message.

Home subscriber system (HSS) 126 refers to a network element that manages the profile of the subscriber's service stored in network storage device 110, the initial filter criteria, and identifies the filters that must be engaged in the call to assist in call processing and provide services during the call. The filter criteria define the call control logic and the conditions under which services to which the customer has subscribed are invoked during the call. The filter criteria also define the different application servers that are engaged in the call session to provide applications and services. The ring tone service manager 108 operates on an application server and is identified within the initial filter criteria.

Interrogating call session control function (I-CSCF) 128 refers to the entry point of a call to the network 106 from another network (e.g., packet-switched network 138 and PSTN network 134 via MGCF 130).

Media gateway control function (MGCF) 130 receives the call from a circuit-switched network, e.g., PSTN network 134 or a cellular network and translates the associated protocols to IP-based protocols so the IMS network 106 is able to handle the call.

Proxy call session control function (P-CSCF) 136 refers to an element of network 106 and is the entry point for an IMS-enabled device (e.g., communications device 102g) into the IMS network 106. Generally, the P-CSCF 136 is the first/last IMS network 106 element that communicates with the end point IMS device (e.g., the communications device being called such as communications devices 102a-e).

A third-party storage device 114 is also provided in the system of FIG. 1. Third-party storage device 114 refers to a library of ring tones that is offered by an entity that is not related to the provider of the ring tone services. One or more libraries of ring tones available for selection by users of communications devices 102a-e may be viewed and purchased via, e.g., a link to the storage device 114 provided by the ring tone service manager 108. These ring tone offerings may be provided to the customers of the ring tone service system as a value-added service to increase the pool of available ring tones for selection.

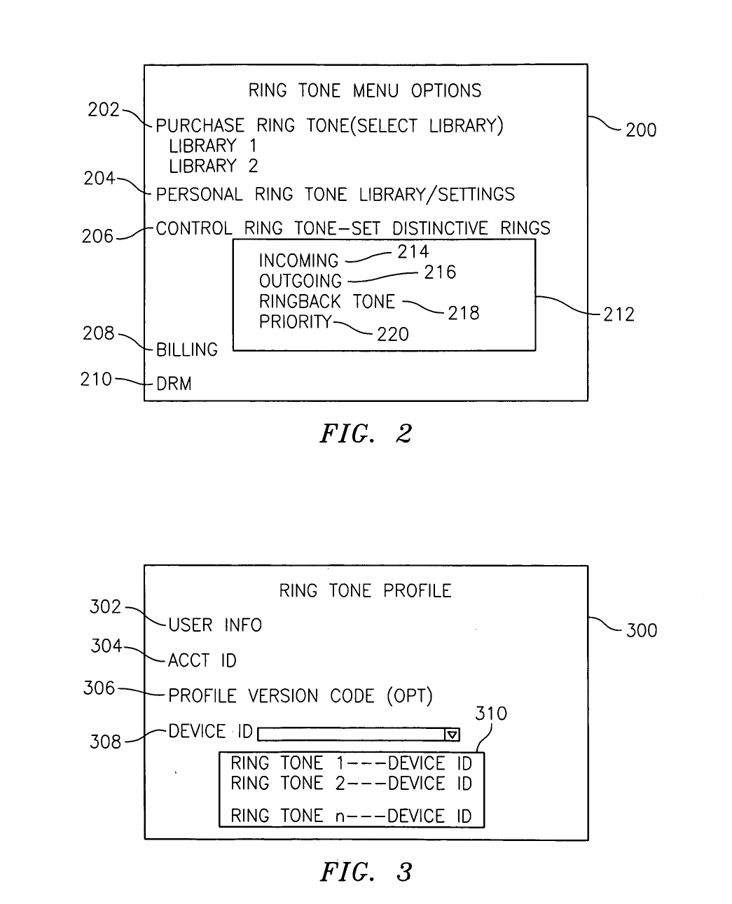

Network storage device 110 is also provided in the system of FIG. 1 and includes a repository of ring tones that may be directly provided to customers of the ring tone services by the provider of the ring tone services. Also stored in network storage device 110 may be user or customer profiles, e.g., records of data that enable the ring tone service manager application 120 to track and manage individual ring tone selections and settings. A sample profile record 300 is shown and described in FIG. 3. Ring tone records may also be stored in network storage device 110 of FIG. 1. Ring tone records refer to data temporarily stored by the ring tone service manager application 120 when a communications device (e.g., 102a-e) is not available during the time the ring tone service manager application 120 seeks to synchronize the user settings associated with one or more communications devices 102a-e (e.g., updates, changes to the ring tones, ring tone settings of a user). The synchronization activities are described further in FIGS. 5 and 6. The network storage device 110 may be coupled to the ring tone service manager 108 via IMS network 106 (e.g., HSS 126) or other suitable means.

Local storage device 122 is also included in the system of FIG. 1. Local storage device 122 refers to memory (e.g., hard drive, floppy drive, cache memory, etc.) either physically separate from the communications devices 102a-e or incorporated internally within one or more of devices 102a-e. In the client device-based implementation, local storage device 122 may store some or all of the ring tone selections purchased or selected by a user of the ring tone services, as well as the user settings.

Billing system 112 refers to a network element that enables the enterprise or service provider implementing the ring tone services to conduct billing activities in response to the ring tone services it provides. Billing system 112 may be implemented using one or more servers operating in response to a computer program stored in a storage medium accessible by the server of billing system 112. For example, a user of a communications device 102a selects multiple ring tones and applies ring tone settings for these selections. The ring tone service manager application 120 may provide this information to the billing system 112, which in turn, generates a record of charges for conducting billing and payment services. In addition, the billing system 112 may be implemented on behalf of the ring tone service manager application 120 for reimbursing, e.g., third-party storage device 114 when a user selects a ring tone from the third-party ring tone provider. These subscriber billing records and records relating to third-party provided ring tones may be stored in a billing storage device 113 that is coupled to, or in communication with, billing system 112.

The system of FIG. 1 also includes communications devices 102f and 102g. Communications device 102f represents a device that communicates with the network 106 via a circuit-switched network (e.g., PSTN network 134) or cellular network. Communications device 102f may be similar to other communications devices 102a-e; however, communications device 102f is not a subscriber to the ring tone services described herein. Communications device 102g is also included in the system of FIG. 1 and communicates with network 106 via a packet-switched network (e.g., network 138). As with communications device 102f, communications device 102g may also be similar in function to the communications devices 102a-e described above. Communications device 102g refers to a device that is registered with, or subscribes to, the ring tone services described herein. Communications devices 102f and 102g are described further herein.

As indicated above, the ring tone services may be implemented locally on a client device (e.g., communications devices 102a-e) or may be performed over a network. In either implementation, a user interface is provided (e.g., user interface 118) for registering for the services and establishing or editing user settings.

Turning now to FIG. 2, a user interface window 200 depicting sample menu options provided by the user interface 118 (or by the ring tone client application 104 via a device user interface) is shown. A user of the ring tone services (e.g., a subscriber who is a registered member of the ring tone services) may access this window 200 from any web-enabled device (e.g., one or more of communications devices 102a-e). Options available via the computer window 200 include, e.g., purchasing a ring tone 202, selecting or editing current ring tone settings 204, controlling ring tones 206, viewing and/or implementing payment functions 208, and viewing digital rights management information 210. Digital rights management information 210 provide the nature and extent of the ring tone usage by subscribers of the services (e.g., the ring tones purchased may not be shared with other individuals). As shown in the window 200 of FIG. 2, the ring tone service manager application 120 may provide a listing of available ring tone libraries to choose from via option 202. Libraries may be provided by the provider of the ring tone services (e.g., stored in network storage device 110), or may be links to third-party ring tone libraries (e.g., third-party ring tone storage device 114). Once selected, the ring tone is associated with the subscriber's personal ring tone library.

The personal ring tone library/settings option 204 enables a user to view selected ring tones stored in his/her personal library on the network storage device 110 (or downloaded to the device), as well as provide information relating to the requirements of each of the devices registered for the ring tone services. For example, one of the user's devices may not support a video tone service, while another device may not support the amount of memory required to implement a particular ring tone. These, and other types of settings may be implemented via option 204.

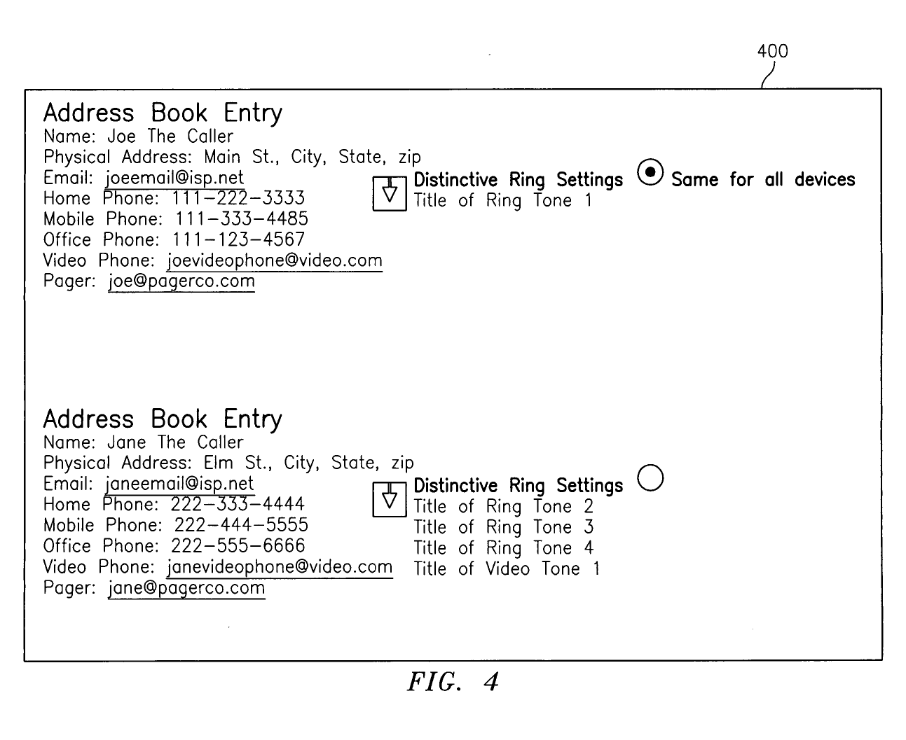

The user may set distinctive ring tones via the control ring tone option 206. A subwindow 212 provides a sampling of the types of distinctive ring tone features that may be available through the ring tone service system. Option 214 enables a user to set a distinctive ring tone for incoming calls (e.g., from communications devices 102f-g). This may be implemented by associating a phone number in an online, computer-based, or phone-based address book with the selected ring tone. A sample electronic address book illustrating this feature is shown in the diagram of FIG. 4. If desired, the user may set the distinctive ring for application to all devices associated with, e.g., the user's residential phone number VoIP service. The user may also set the distinctive ring for application to his/her cellular telephone or other phones associated with other telecommunication services (e.g., work phone number). Additionally, the user may set his/her distinctive ring services to allow a caller with distinctive ring for call delivery service (e.g., communications device 102g) to override the distinctive ring receiving service.

Option 216 enables a user to set distinctive ring tones for call delivery for outgoing calls (e.g., calls to IMS-enabled communications device 102g). This may be accomplished via, e.g., the web interface 118, whereby the user associates a phone number from, e.g., his/her online address book with a ring tone for the distinctive ring service for call delivery for outgoing calls.

Option 218 enables a user to set distinctive ringing for ring back tones. A ring back tone is the audio tone or video image that the caller hears or sees while the called device is ringing and waiting to be answered. This option may be accomplished via, e.g., the web interface 118, as described above with respect to options 214 and 216.

Additionally, a user may set priorities for receiving distinctive ringing from a caller via option 220. The distinctive ringing delivery service allows a caller to define a distinctive ring that should be delivered to the called phone (e.g., IMS-enabled communications device 102g). The user of the called phone, through the option 220, may define from which callers he or she will receive the caller's distinctive ring. For example, the user of the called phone may set a particular ring tone for all calls that are from a caller ID that is not in the called party's address book and may also deny those callers that are calling from a caller ID that is not in the address book from delivering a distinctive ring to the called phone. In another example, the user of the called phone may set a distinctive ring for the caller ID associated with his mother and may also assign permission to his mother's caller ID to allow a distinctive ring selected by his mother to be delivered to the user's phone's during call setup. If the mother defines a distinctive ring to be delivered to her son's phone when she calls it, the ring tone delivery service will deliver the distinctive ring to the son's phone when it is called.

Once a user has registered for the ring tone services, a profile record (also referred to as user profile) for the user is created by the ring tone service manager application 120 and stored in network storage device 110. Turning now to FIG. 3, a sample profile record 300 is shown and described. Record 300 provides general information relating to the user/subscriber of the ring tone services via a user information field 302. The record 300 may also include an account identifier 304 for distinguishing the user from other subscribers. A profile version code field 306 may be included in the profile record 300 in order to implement the automatic synchronization features described further herein. The user may also view devices that are currently registered for the services via, e.g., a drop down field 308. A subwindow 310 displays a listing of the user's selected ring tones and corresponding devices.

As indicated above, the ring tone service system may be implemented via a network (e.g., IMS network 106 and ring tone service manager 108) or via a client device (e.g., communications device 102e and ring tone client application 104). In accordance with exemplary embodiments, these ring tone services may be implemented utilizing automatic synchronization of one or more ring tones across all devices owned or under the control of a subscriber. In accordance with exemplary embodiments, communications devices 102a-e are enabled with automatic synchronization capabilities (e.g., SyncML or something similar). SyncML Open Mobile Alliance Ltd™ provides an open protocol for mobile data synchronization and a single common data synchronization protocol usable industry wide. In exemplary embodiments, the ring tone service manager application 120 also includes these synchronization capabilities.

Turning now to FIG. 5, a client device-based implementation of the ring tone services will now be described. In the processes described with respect to FIG. 5, it is assumed that a communications device user is a current subscriber of the ring tone services and a subscriber profile (e.g., profile record 300) exists for the user. The process begins at step 502 whereby the ring tone client application 104 on a device (e.g., communications device 102e) under the control of the user is initialized at step 504. The initialization may be overt, e.g., a user accessing the ring tone client application 104 on the device, or may be implicit, e.g., a device is activated or powered on, signaling initialization of the ring tone client application 104.

At step 506, the ring tone client application 104 establishes a connection with the ring tone service manager 108. The connection may be of any transport protocol, including HTTP, Wireless Session Protocol (WSP), OBEX (Bluetooth™, IrDA), SMTP, TCP/IP, or any proprietary communication protocol. The ring tone service manager 108 accesses network storage device 110 for the profile record of the subscriber associated with the device and checks to see if a new profile record exists (if the subscriber has recently registered) or if an update to an existing profile has been made at step 508. This may be performed by checking the profile version code 306 of the profile record 300 shown in FIG. 3. The profile version code 306 provides an indicator of the most recent transaction occurring for the communications device and reflects the most current change in service. The profile version code 306 may be incremented each time a change is made to the subscriber's services or may be implemented by a timestamp associated with the changes.

At step 510, it is determined if a new profile record, or an update to an existing profile record exists. If not, this indicates that the settings are current. Accordingly, no action is taken and the device continues to operate with the current ring tone settings that are stored in the devices and the process ends at step 528. Otherwise, the device sends a request to the ring tone service manager 108 for an over-the-air synchronization utilizing, e.g., syncML protocol at step 512. At step 514, the device receives the updated settings as a result of the synchronization conducted at step 512 and stores the settings locally at step 516 (e.g., local storage device 122).

At step 518, it is determined if synchronization of additional devices associated with the subscriber is desired. If not, the process ends at step 528. Otherwise, it is determined what type of synchronization is desired at step 520. For example, the subscriber devices may be synchronized using a peer-to-peer process or via network elements. Peer-to-peer synchronization may be performed by sending updates or new settings from the device synchronized in step 514 to any additional devices specified by the subscriber via, e.g., syncML protocol enabled on the applicable devices. Network synchronization may be accomplished in a similar manner as that described above in steps 504-516 whereby the additional devices to be synchronized individually request over-the-air synchronization upon initialization.

If peer-to-peer synchronization is desired at step 520, the synchronized device from step 514 starts a synchronization attempt counter at step 521, establishes a connection with the next device to be synchronized at step 522, and sends the new settings to the device at step 524. The synchronization attempt counter may be based on the number of synchronization attempts or on time. If based on number of attempts, the counter is updated at step 525. At step 526, it is determined whether the counter has exceeded the specified count. If so, the process ends at step 528. Otherwise, it is then determined whether there are any additional devices to be synchronized at step 530. If synchronization is complete at step 530, the process ends at step 528. Otherwise, the process returns to step 522 whereby the device continues to establish connections with the remaining devices to be synchronized.

Returning back to step 520, if network synchronization is desired, the process returns to step 504 whereby each device to be synchronized initiates the synchronization process upon initialization (steps 504-516). If any of the devices to be synchronized remain inactive, the ring tone service manager 108 may store a ring tone record in network storage device 110 for each of the devices that have not received the most recent update.

When an incoming call comes to the device, the ring tone client application 104 is engaged and checks the caller ID of the incoming call. Based on the caller ID and the ring tone settings in the ring tone client application 104, the ring tone client application 104 searches the locally stored settings (e.g., tables within the memory of the device) and extracts the appropriate ring tone to play on the device. The ring tones and ring tone setting table may accessed based upon the number dialed or address to which the communication session is made, and caller line ID (or other identifier associated with the initiator of the communication). Upon receipt of an incoming call, the ring tone client application 104 in the communications device accesses the table in memory and, based on the number dialed and the caller line ID, plays the ring tone based on the current ring tone settings.

As indicated above, the ring tone services may be implemented via a network during a call set up or may be implemented via control logic resident on a device (e.g., communications devices 102a-g). Turning now to FIG.6, a flow diagram describing the network-based implementation of the ring tone services in accordance with exemplary embodiments will now be described. In the network-based implementation, the ring tone is pushed to the device during call setup using, e.g., SIP signaling in the network 106 and a modified SIP client in the device (e.g., communications devices 102a-e) with a ring tone/video tone client. In exemplary embodiments, the communications devices of the subscriber (e.g., 102a-e) support IP-based signaling for call setup. Also, the communications devices support SIP signaling (or other suitable signaling means). Further, the communications devices include a SIP client for implementing call set up and support for voice calls, and which also may be integrated with a ring tone client and a video tone client. Through SIP signaling, the IP transport, the SIP client, and ring tone client, the ring tone service manager 108 is able to send a ring tone with the call set up to the communications device on a per-call basis.

A call is initiated for the purpose of contacting a subscriber associated with one of communications devices 102a-e. The call is received by the IMS network 106 at step 602. The call maybe initiated from one of communications device 102f or 102g as described herein. If the call originates from communications device 102f via PSTN network 134, the MGCF 130 may be first to receive the call in order to translate the protocol associated with the PSTN/cellular network to an IP-based protocol that is understood by IMS network 106. If the call originates from communications device 102g, the call may be forwarded to I-CSCF 128 rather than MGCF 130. This is because the calling device is either a subscriber of the ring tone services and consequently does not need translation, or the call information is already presented in an IP-based protocol format. For calls originating from communications device 102f, the MGCF 130 may then seize a trunk in the media gateway (MGW) 132 that is used to support the bearer channel of the call. The MGCF 130 may also send a SIP INVITE message with call-related information (e.g., caller ID, dialed digits, etc.) to the I-CSCF 128.

The I-CSCF 128 determines the IP address in the network 106 for the communications devices (e.g., 102a-e) associated with the subscriber of the ring tone services, as well as to determine the address of the S-CSCF 124. The I-CSCF 128 then forwards the SIP INVITE message with call-related information to the S-CSCF 124. The S-CSCF 124 may retain the location with the IP network of the subscriber's communications devices 102a-e as well as the subscriber's filters, which it receives from the HSS 126 as part of the registration process of the subscriber's devices 102a-c. In the event the S-CSCF 124 does not have current information about the subscriber, it may query the HSS 126 during the call process to determine the subscriber's profile (e.g., service point triggers for calling processing which tells the S-CSCF 124 to query the ring tone service manager 108, and the addresses of the ring tone service manager 108, address of the subscriber's devices 102a-e, etc.).

The S-CSCF 124 queries the ring tone service manager 108 and sends the call-related information and subscriber identifier (e.g., account ID 404 of FIG. 4) at step 604. The ring tone service manager 108 looks at the ring tone service settings in the profile record 400 for the subscriber at step 606 and, based on the caller line ID or other identifiers associated with the caller, the ring tone service manager 108 extracts the ring tone for the call from storage device 110 at step 608. The ring tone service manager 108 provides the ring tone to the S-CSCF 124 at step 610, which in turn contacts the device at step 612 and forwards the SIP INVITE with the ring tone/video tone, and supporting information (device requirements) to the appropriate communications devices 102a-e at step 614.

When the SIP client in the receiving communications device (e.g., communications devices 102a-e) receives the SIP INVITE message, it engages either the ring tone client or the video tone client (depending upon the supporting information received). The SIP client 105 (or other suitable tool) in the device 102e receives the INVITE message and replies with a message to send the ring tone or video tone at step 616. The IMS network 106 sends a message to the device indicating which type of tone it will send (e.g., none, ring tone, video tone) at step 618. Based upon this message, the SIP client 105 engages either the ring tone client application or video tone client application (104) and responds to the IMS network 106 to send the appropriate tone. The IMS network 106 receives the response at step 620 and sends the appropriate tone accordingly to the device at step 622.

In the event the receiving communications device (e.g., 102a-e) does not support the required functionality (e.g., media player, insufficient memory), it may present an error message to the subscriber via, e.g., a display screen of the communications device, and complete the call set up process by instructing the ring tone client to play a default standard ring tone, which is then played on the device.

As indicated above, the ring tone services provide network-delivered ring tone services to a device by network elements either upon request or during a call setup. In alternative embodiments, the ring tones are resident in the devices and the ring tone service manager 108 is not involved in delivering the ring tone during call setup. According to an exemplary embodiment, all of the ring tone logic is resident on the device in the ring tone client application 104.

As described above, the present invention can be embodied in the form of computer-implemented processes and apparatuses for practicing those processes. The present invention can also be embodied in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims.

What is claimed is:

1. A method for providing tone services, comprising:
associating a tone with a communications address;
storing results of the associating in a profile record; and
in response to receiving an incoming call directed to the communications address, accessing the profile record to find the tone and delivering the tone along with the incoming call to a communications device associated with the communications address.

2. The method of claim 1, further comprising:
associating distinctive ring functions to the communications address;
storing results of the associating distinctive ring functions in the profile record; and
in response to receiving an incoming call directed to the communications address, accessing the profile record to find the distinctive ring functions and implementing the distinctive ring functions along with the incoming call to a communications device associated with the communications address.

3. The method of claim 1, wherein the tone includes at least one of:
a ring tone;
a video tone; and
a ring back tone.

4. The method of claim 1, further comprising:
receiving a change to the profile record, the change including at least one of a change to a selected tone and a change to a distinctive ring function setting; and
implementing the change on the communications device during call set up.

5. The method of claim 1, wherein the distinctive ring functions include at least one of:
applying a selected tone to incoming calls of the communications device;
applying a selected tone to outgoing calls initiated by the communications device;
applying a selected tone as a ring back tone; and
establishing priorities for selected distinctive ring functions associated with the communications device.

6. The method of claim 1, wherein the communications device includes at least one of:
a personal computer;
a laptop computer;
a cellular telephone;
a Session Initiated Protocol-enabled cordless telephone;
a Session Initiated Protocol-enabled wireline telephone; and
a pager.

7. A system for providing tone services, comprising:
a processor executing a tone service manager application, the processor in communication with a communications device via a network, the ring tone service manager application performing:
associating a tone with a communications address;
storing results of the associating in a profile record; and
in response to receiving an incoming call directed to the communications address, accessing the profile record to find the tone and delivering the tone along with the incoming call to a communications device associated with the communications address.

8. The system of claim 7, wherein the tone service manager application further performs:
associating distinctive ring functions to the communications address;
storing results of the associating distinctive ring functions in the profile record; and
in response to receiving an incoming call directed to the communications address, accessing the profile record to find the distinctive ring functions and implementing the distinctive ring functions along with the incoming call to a communications device associated with the communications address.

9. The system of claim 7, wherein the tone includes at least one of:
a ring tone;
a video tone; and
a ring back tone.

10. The system of claim 7, wherein the tone service manager application further performs:
receiving a change to the profile record, the change including at least one of a change to a selected tone and a change to a distinctive ring function setting; and
implementing the change on the communications device during call set up.

11. The system of claim 7, wherein the distinctive ring functions include at least one of:
applying a selected tone to incoming calls of the communications device;
applying a selected tone to outgoing calls initiated by the communications device;
applying a selected tone as a ring back tone; and
establishing priorities for selected distinctive ring functions associated with the communications device.

12. The system of claim 7, wherein the communications device includes at least one of:
a personal computer;
a laptop computer;
a cellular telephone;
a Session Initiated Protocol-enabled cordless telephone;
a Session Initiated Protocol-enabled wireline telephone; and
a pager.

13. The system of claim 7, wherein the network includes:
a serving call session control function;
a home subscriber system;
an interrogating call session control function;
a media gateway control function; and
a proxy call session control function.

14. A computer program product for providing tone services, the computer program product including instructions for performing:
associating a tone with a communications address;
storing results of the associating in a profile record; and
in response to receiving an incoming call directed to the communications address, accessing the profile record to find the tone and delivering the tone along with the incoming call to a communications device associated with the communications address.

15. The computer program product of claim 14, further comprising instructions for performing:
associating distinctive ring functions to the communications address;
storing results of the associating distinctive ring functions in the profile record; and
in response to receiving an incoming call directed to the communications address, accessing the profile record to find the distinctive ring functions and implementing the distinctive ring functions along with the incoming call to a communications device associated with the communications address.

16. The computer program product of claim 14, wherein the tone includes at least one of:
a ring tone;
a video tone; and
a ring back tone.

17. The computer program product of claim 14, further comprising instructions for performing:
receiving a change to the profile record, the change including at least one of a change to a selected tone and a change to a distinctive ring function setting; and
implementing the change on the communications device during call set up.

18. The computer program product of claim 14, wherein the distinctive ring functions include at least one of:
applying a selected tone to incoming calls of the communications device;
applying a selected tone to outgoing calls initiated by the communications device;
applying a selected tone as a ring back tone; and
establishing priorities for selected distinctive ring functions associated with the communications device.

19. A communications device for providing tone services, comprising:
a synchronization protocol enabled on the communications device; and
a tone client application executing on the communications device, the tone client application performing:
downloading a tone on the communications device;
applying distinctive ring settings to the communications device;
automatically transmitting the tone and the distinctive ring settings to an other communications device via the synchronization protocol; and
implementing the tone on the communications device.
